(19) United States
(12) Patent Application Publication
(10) Pub. No.: US 2006/0066887 A1
(43) Pub. Date: Mar. 30, 2006

(54) Image forming apparatus and control method therefor

(75) Inventors: Tadaaki Saida, Kashiwa-shi (JP); Akihito Mori, Toride-shi (JP); Nobuo Sekiguchi, Moriya-shi (JP); Keita Takahashi, Abiko-shi (JP); Takashi Nagaya, Moriya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/222,833

(22) Filed: Sep. 12, 2005

(30) Foreign Application Priority Data
Sep. 30, 2004 (JP) 2004-287994(PAT.)

(51) Int. Cl. G06F 3/12

(52) U.S. Cl. 358/1.13

(57) ABSTRACT

In an image forming apparatus having a discrimination mechanism that identifies an input document image as a color image or a monochrome image and an area recognition mechanism that recognizes a plurality of different areas contained in the document image, the apparatus applies the optimum color image forming mode even if the document is identified as a color image and forms an image. The user is permitted to select either a first color image forming mode that uses recording agents of m colors (where m is a natural number equal to or greater than 4) or a second color image forming mode that uses recording agents of n colors (where n is a natural number equal to or greater than m+1) as a color image forming mode applied to at least one of the areas recognized by the area recognition mechanism. If the input document image is identified as a color image, the apparatus applies the selected color image forming mode to at least one of the areas recognized by the area recognition mechanism and forms an image.

### FIELD OF THE INVENTION

This invention relates to an image forming apparatus capable of forming a color image and a control method therefor.

### BACKGROUND OF THE INVENTION

A color image forming apparatus has been proposed that switches between an image forming mode of forming an image using the conventional YMCK (yellow, magenta, cyan and black) four-color toner and an image forming mode of forming an image using five or more colors by further combining the four-color toner with a light color toner (Japanese Patent Application Laid-open No. 2004-145150).

By contrast, a color image forming apparatus has also been studied that determines whether a document image is a monochrome image or a color image using a discrimination mechanism, and automatically switches to a monochrome image forming mode or a color image forming mode depending on the type of image. According to this color image forming apparatus, in general, the color toner is used only when a color image is detected, and consequently the working life of consumable material such as the toner can be extended. It should be noted that the mechanism that automatically determines whether an image is a monochrome image or a color image is called an ACS (Auto Color Selection) mechanism.

Assume that a plurality of color image forming modes, such as the four-color image forming mode or the color image forming mode using five or more colors described in Japanese Patent Application Laid-open No. 2004-145150, is adapted to an image forming apparatus that employs ACS. In such an instance, although the current ACS mechanism can determine whether the document image is a monochrome image or a color image depending on the document image, depending on the document image it cannot determine whether it should employ four-color image formation or five-color image formation.

Consequently, it must be decided by one means or another whether to use four-color image formation or five-color image formation. Preferably, although it is necessary to allow the user to select whether to use four-color image formation or five-color image formation, making the user make this selection each time an image is formed can prove bothersome to the user.

On the other hand, switching may be accomplished by disabling or removing the ACS mechanism setting the monochrome image forming mode, the four-color image forming mode and the five-color image forming mode as the default setting. With such a configuration, however, there is a risk that the four-color image forming mode or the five-color image forming mode may be used even with a monochrome image, thus wasting color consumable material.

Therefore, even with a color image forming apparatus that employs the ACS mechanism, it can be said to be desirable to be able to switch easily between a first color image forming mode using m colors of toner or ink (where m is a natural number equal to or greater than 4) and a second color image forming mode that uses n colors of toner or ink (where n is a natural number equal to or greater than m+1) depending on the user's wishes.

### SUMMARY OF THE INVENTION

Accordingly, the present invention has as an object to solve at lease one of the foregoing as well as other problems, such other problems becoming apparent upon a reading of the entire specification.

In order to solve the above-described problems, the present invention provides, according to one embodiment of the present invention, an image forming apparatus comprising:
an image input unit that inputs a document image;
an area recognition unit that recognizes a plurality of different areas contained in the document image;
an identification unit that identifies the document image as either a color image or a monochrome image;
a selection unit that allows a user to select either a first color image forming mode that uses recording agents of m colors (where m is a natural number equal to or greater than 4) or a second color image forming mode that uses recording agents of n colors (where n is a natural number equal to or greater than m+1) as an image forming mode applied to at least one of the areas recognized by the area recognition unit if the identification unit identifies the document image as a color image; and
an image formation unit that applies the image forming mode selected by the selection unit to at least one area and forms an image.

According to the present invention, even if an identification function that identifies whether the document image is a color image or a monochrome image and an area recognition function that recognizes a plurality of different areas contained in the document image are set, a suitable image forming mode can be applied to the recognized areas.

Other features, objects and advantages of the present invention are apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an illustrative block diagram showing an image forming apparatus according to the present embodiment;

FIG. 2 is an illustrative flow chart showing a control method for the image forming apparatus according to the present embodiment;

FIG. 3 is another illustrative flow chart showing a control method for the image forming apparatus according to the present embodiment;

FIG. 4 is another illustrative flow chart showing a control method for the image forming apparatus according to the present embodiment;

FIG. 5 is another illustrative flow chart showing a control method for the image forming apparatus according to the present embodiment;

FIG. 6 is another illustrative flow chart showing a control method for the image forming apparatus according to the present embodiment;

FIG. 7 is a diagram showing a schematic cross-sectional view of an electrophotographic full color image forming apparatus that is one example of the image forming apparatus according to the present embodiment;

FIG. 8 is a block diagram showing a control unit of the image forming apparatus according to the present embodiment;

FIG. 9 is a diagram showing one example of a user interface (control panel) of the image forming apparatus according to the present embodiment;

FIG. 10 is a diagram showing an example of a screen for the purpose of registering a default setting with respect to a print mode setting in the present embodiment;

FIG. 11 is an illustrative flow chart of a control method for the image forming apparatus according to the present embodiment;

FIG. 12 is an illustrative flow chart of a control method for the image forming apparatus according to the present embodiment; and

FIG. 13 is a diagram showing an illustrative user interface for selecting an image forming mode in the image forming apparatus according to the present embodiment.

### DETAILED DESCRIPTION OF THE PREFERRED EMBODIMENT(S)

Preferred embodiments of the present invention will now be described in detail according to the accompanying drawings.

The following illustrates an embodiment useful to an understanding of the generic concept, the intermediate concept, and the more specific concept of the present invention. It should be noted that not necessarily all the concepts contained in the following embodiment are recited in the claims. However, such omission is not an intentional removal from the claims of the patent invention, and it is to be understood that that which is not specifically recited in the claims may be equivalents of the patent invention.

### First Embodiment

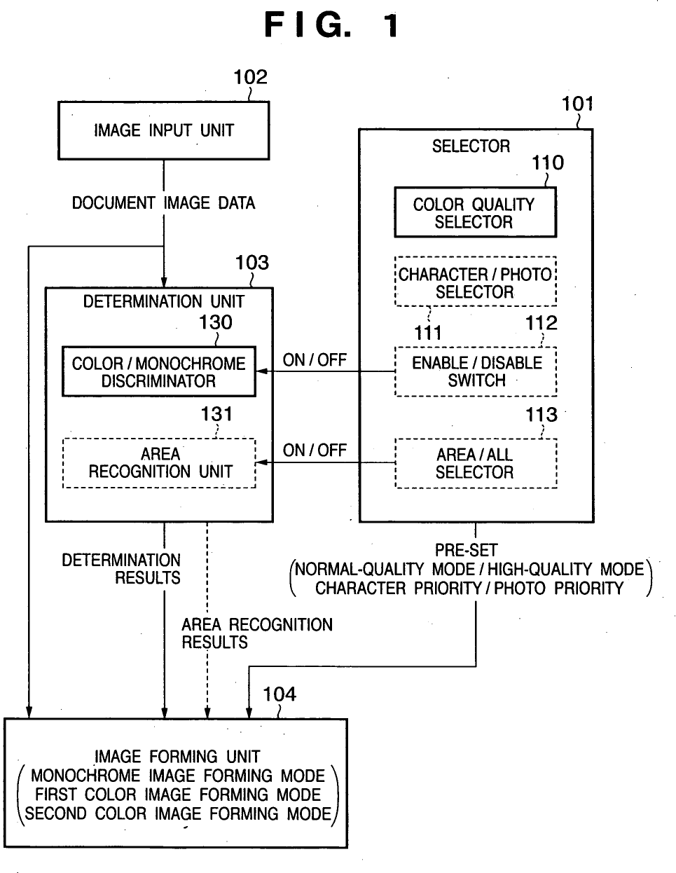

FIG. 1 is an illustrative block diagram showing an image forming apparatus according to the present embodiment. The image forming apparatus may, for example, be an electrophotographic, inkjet or other type of color printer, color copier, color facsimile machine or color multifunctional peripheral.

A selector 101 is equipped with a color quality selector 110 that allows a user to select in advance a first color image forming mode that uses toner or ink (recording agent) of m colors (where m is a natural number equal to or greater than 4) or a second color image forming mode that uses toner or ink of n colors (where n is a natural number equal to or greater than m+1).

It should be noted that the color quality selector 110 can be configured as a first designator that designates an image forming mode applied in a case in which a determination unit is enabled and a second designator that designates an image forming mode applied in a case in which the color/monochrome discriminator 130 is disabled. If the color/monochrome discriminator 130 is enabled and the input document image is identified as a color image, the first designator designates either forming an image with the first color image forming mode or forming an image with the second color image forming mode. If the color/monochrome discriminator 130 is disabled, the second designator designates forming an image with the first color image forming mode, the second color image forming mode, or the monochrome image forming mode.

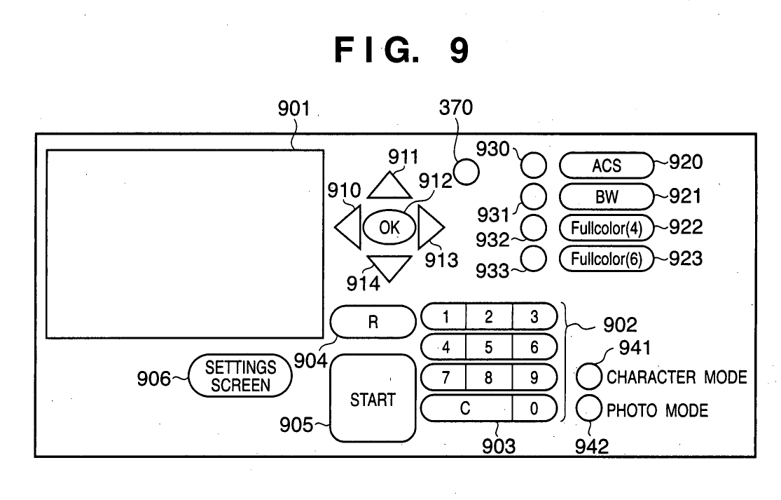

In addition, a selector for interrupting the image forming process and allowing the user to select a color image forming mode may be included in the color quality selector 110. Furthermore, a selector for allowing a color image forming mode applied to a character area to be selected and a selector allowing a color image forming mode applied to a photo area to be selected for also may be included in the color quality selector 110. A description of one example of a specific user interface will be given later using FIG. 9.

The color quality selector 110 may be implemented by, for example, a ROM on which the control program is stored, a CPU that executes the control program, a RAM that provides work area and an input-output device (such as a touch panel display or the like) that functions as a user interface.

It should be noted that the color quality selector 110 may also be provided with at least one of a character/photo selector 111, an enable/disable switch 112 and an area/all selector 113 as an option or options. Here, the character/photo selector 111 selects between a character mode that carries out character-priority image formation and a photo mode that carries out photo quality-priority image formation. In addition, the enable/disable switch 112 switches the color/monochrome discriminator 130 on and off.

Furthermore, the area/all selector 113 recognizes a character area and a photo area contained in the document image and selects either an individual mode that applies different image forming modes to each of the recognized areas or an all mode that applies the same image forming mode to the entire document image. These modes may, for example, be provided either together with the color quality selector 110 or in place of the color quality selector 110.

An image input unit 102 is a reader unit for inputting a document image. A determination unit 103 is provided with the color/monochrome discriminator 130 that determines whether the input document image is a color image or a monochrome image. In other words, the color/monochrome discriminator 130 corresponds to the ACS mechanism described above.

It should be noted that an area recognition unit 131 that recognizes a character area and a photo area contained in the document image may be provided in the determination unit 103 as an option. The area recognition results is useful when applying separate image forming modes to the character area and the photo area.

If an input document image is identified as a color image, the image forming unit 104 forms an image with the color image forming mode selected in advance by the color quality selector 110. If the input document image is identified as a monochrome image by the color/monochrome discriminator 130, the image forming unit 104 forms an image with the monochrome image forming mode. The image forming unit 104 may, for example, be composed of a printer engine, a control unit that controls the printer engine, and so forth.

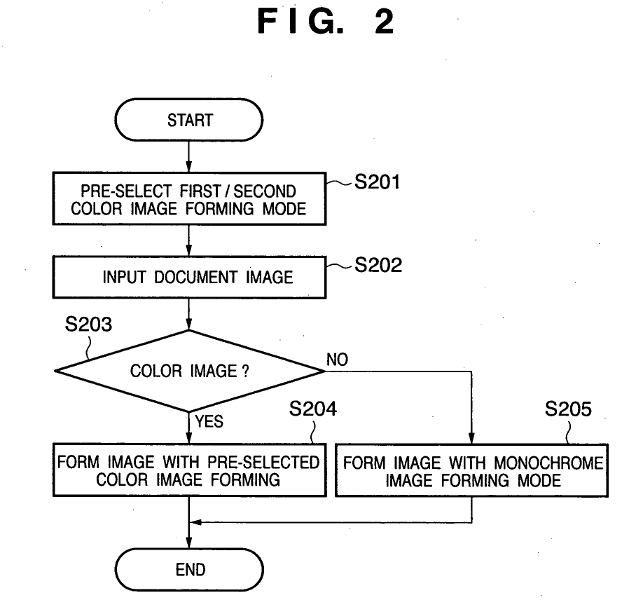

FIG. 2 is an illustrative flow chart showing a control method for the image forming apparatus according to the present embodiment. In step S201, in response to an instruction from the user, the color quality selector 110 selects in advance either the first color image forming mode that uses m colors of toner or ink (m being a natural number equal to or greater than 4) or the second color image forming mode that uses n colors of toner or ink (n being a natural number equal to or greater than m+1). The pre-selecting process may be executed as a default setting when the apparatus is shipped from the factory, or the user may be allowed to select one of the color image forming modes by displaying a setting display screen displayed on the user interface when an arbitrary key is pressed.

In step S202, the image input unit 102 inputs a document image in response to an instruction from the user. In step S203, the color/monochrome discriminator 130 determines if the input document image is a color image or a monochrome image. If the input document image is a color image, then the process proceeds to step S204. If the input document image is a monochrome image, then the process proceeds to step S205. It should be noted that the color/monochrome discriminator 130 can be set to enabled by the enable/disable switch 112. It goes without saying that if, however, the color/monochrome discriminator 130 is set to disabled by the enable/disable switch 112, then an image is formed using the image forming mode designated by the second designator described above.

If in step S203 it is determined that the input document image is a color image, then in step S204 the image forming unit 104 forms an image with the color image forming mode selected in advance at the selector 101.

If in step S203 it is determined that the input document image is a monochrome image, then in step S205 the image forming unit 104 forms an image in the monochrome image forming mode.

According to the present embodiment, since the image forming apparatus has a discrimination mechanism that determines whether the input document image is color image or a monochrome image and forms an image using a color image forming mode selected in advance if it is determined that the input document image is a color image, it is no longer necessary for the user to select the color image forming mode each time an image is formed, thereby saving time and trouble. In addition, the monochrome image forming mode is applied if the input document image is identified as a monochrome image, thereby enabling the wastage that occurs whenever color consumable material is used despite the fact that the input document image is a monochrome image to be decreased. Accordingly, the working life of the color consumable material can be extended.

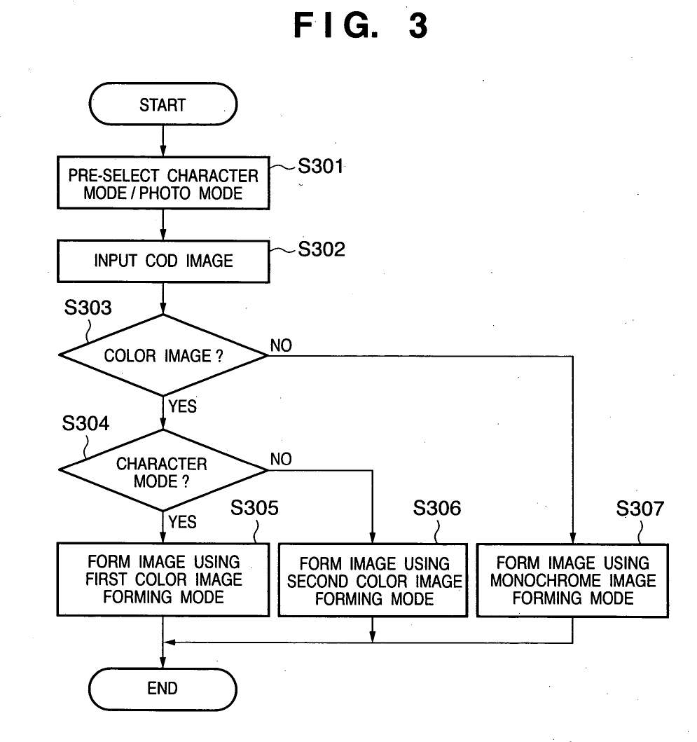

FIG. 3 is another illustrative flow chart showing a control method for the image forming apparatus according to the present embodiment. In particular, the drawing shows a control method in a case in which the image forming apparatus includes the character/photo selector 111.

In step S301, in response to an instruction from the user the character/photo selector 111 selects in advance either a character mode that gives priority to character quality or a photo mode that gives priority to photo quality. The pre-selecting process may be executed as a default setting when the apparatus is shipped from the factory, or the user may be allowed to select one of the color image forming modes by displaying a setting display screen displayed on the user interface when an arbitrary key is pressed.

In step S302, the image input unit 102 inputs a document image in response to an instruction from the user. In step S303, the color/monochrome discriminator 130 determines if the input document image is a color image or a monochrome image. It should be noted that the color/monochrome discriminator 130 operates when such operation is enabled in advance by the enable/disable switch 112 as described above. If the input document image is a color image, then the process proceeds to step S304. If the input document image is a monochrome image, then the process proceeds to step S307 and the image forming unit 104 forms an image with the monochrome image forming mode.

In step S304, the image forming unit 104 determines whether or not the character mode has been pre-selected by the user. If the character mode has been selected, then the process proceeds to step S305 and the image forming unit 104 forms an image with the first color image forming mode. By contrast, if the photo mode has been selected by the user, the process then proceeds to step S306 and the image forming unit 104 forms an image with the second color image forming mode.

It should be noted that, compared to the first image forming mode, the second image forming mode can form an image of high quality and therefore is suitable to image formation in the photo mode. By contrast, as can be understood by those of ordinary skill in the art, the first image forming mode is relatively more suited to the character mode. In other words, when the user selects the character mode, it is likely that relatively low-quality image formation is desired. Conversely, when the user selects the photo mode, it is likely that relatively high-quality image formation is desired.

Such an embodiment as described above makes it possible to apply suitably the preferred image forming mode in terms of preserving consumable material while at the same time reflecting the desires of the user even where the operation of an ACS mechanism or the like is enabled.

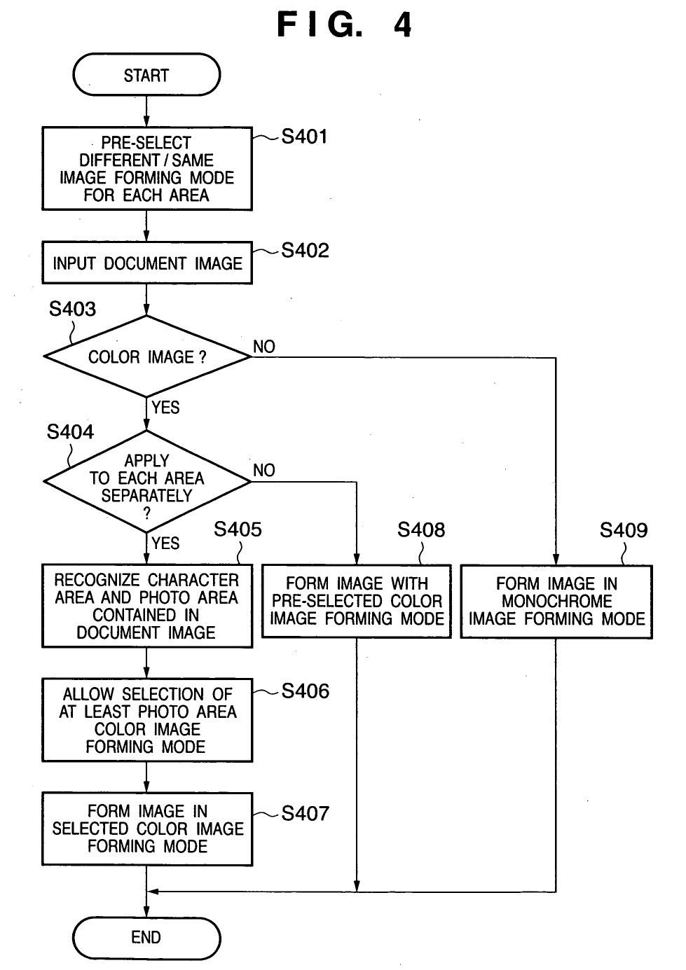

FIG. 4 is another illustrative flow chart showing a control method for the image forming apparatus according to the present embodiment. The control method shown is one in which the image forming apparatus includes the area recognition unit 131 and the area/all selector 113.

In step S401, in response to an instruction from the user, the area/all selector 113 pre-selects either an individual mode that applies different image forming modes to the character areas and to the photo areas of an input document image or an all mode that applies the same image forming mode to both areas.

In step S402, the image input unit 102 inputs a document image in response to an instruction from the user. In step S403, the color/monochrome discriminator 130 determines if the input document image is a color image or a monochrome image. It should be noted that the color/monochrome discriminator 130 operates when such operation is enabled in advance by the enable/disable switch 112 as described above. In step S403, if it is determined that the input document image is a color image, then the process proceeds to step S404. On the other hand, if in step S403 if it is determined that the input document image is a monochrome image, then the process proceeds to step S409 and the image forming unit 104 forms an image in the monochrome image forming mode.

In step S404, the image forming unit 104 determines if the individual mode that applies different image forming modes to each of the character areas and the photo areas has been selected or not in step S401. If the individual mode has been selected, then the process proceeds to step S405. By contrast, if the all mode that applies the same image forming modes to all areas has been selected, the process then proceeds to step S408 and the image forming unit 104 forms an image in the pres-selected image forming mode. It is assumed that the pre-selecting process is executed in step S401, the same as in step S201.

In step S405, the image forming unit 104 activates the area recognition unit 131 and recognizes the character area and the photo area contained in the input document image.

In step S406, the image forming unit 104 temporarily interrupts the image forming process and displays a settings screen on the user interface to allow the user to select at least a color image forming mode (the first or the second color image forming mode) to be applied to the photo area, and accepts the user's selection. At this time, the user may also be allowed to select, via the settings screen, a color image forming mode applied to the character areas as well. Where the color image forming mode is applied to the character areas, typically, application of the first image forming mode is preferable, because, in general, high image quality is not demanded for the character areas.

In step S407, the image forming unit 104, according to the selected color image forming mode, executes image formation using different image forming modes for the character areas and for the photo areas, respectively.

The present embodiment makes it possible, in an image forming apparatus that has an ACS mechanism, to form images that suitably reflect the user's intentions even when applying different image forming methods to the photo areas and the character areas of an input document image.

In particular, as a user interface, where there exists a switching key for switching between a character mode and a photo mode, such a key alone accomplishes nothing more than applying the same image forming mode (that is, the character mode/photo mode, the first color image forming mode/second color image forming mode) across the entire document image. In other words, different color image forming modes for each of the character area and the photo area contained in the document image cannot be selected. The present embodiment enables the user to select image forming modes for each area depending on the user's preferences where a color image has been detected by an ACS mechanism, in an image forming apparatus having both the ACS mechanism as well as the capability to apply different color image forming modes to the character areas and to the photo areas contained in an input document image.

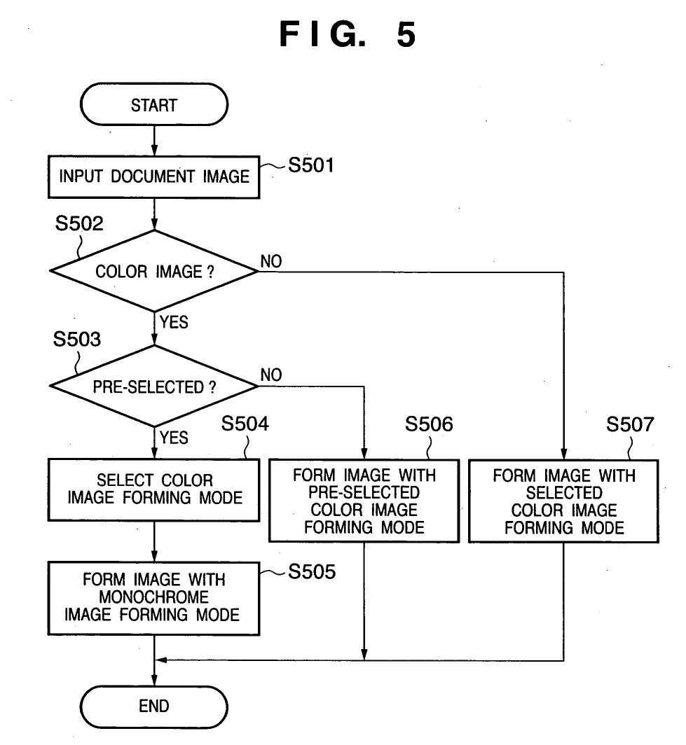

FIG. 5 is another illustrative flow chart showing the control method of the image forming apparatus according to the present embodiment. In particular, in the event that, for one reason or another, which of several color image forming modes to be used is not determined in advance, the user is allowed to select a color image forming mode. In other words, FIG. 5 shows what corresponds to the generic concept of FIG. 4.

In step S501, the image input unit 102 inputs a document image in response to an instruction from the user. In step S502, the color/monochrome discriminator 130 identifies the input document image as either a color image or a monochrome image. If in step S502 it is determined that the input document image is a color image, then the process proceeds to step S503. If in step S502 it is determined that the input document image is a monochrome image, then the process proceeds to step S507 and the image forming unit 104 forms an image with the monochrome image forming mode. It should be noted that the color/monochrome discriminator 130 operates when the enable/disable switch 112 is set to enabled. It goes without saying that, if the color/monochrome discriminator 130 is set to disabled, then the image forming mode designated by the second designator described above is applied and an image is formed.

In step S503, the image forming unit 104 determines whether or not the color image forming mode to be applied to the color image has been pre-selected, for example by determining whether or not pre-selection information exists in the RAM, the ROM, or some other storage means. Alternatively, where, as described above, different color image forming modes are applied to the character area and the photo area, and further, the image forming apparatus uses a user interface that cannot pre-select which color image forming mode is to be applied to each area, the image forming unit 104 determines that the color image forming mode has not been pre-selected. If the color image forming mode has been pre-selected, then the process proceeds to step S506 and the image forming unit 104 forms an image using the previously selected color image forming mode.

If the color image forming mode has not been pre-selected, then the process proceeds to step S504 and the image forming unit 104 temporarily halts the image forming operation, displays a settings screen on the user interface to allow the user to select the first or the second color image forming mode, and accepts the user's selection.

In step S505, the image forming unit 104 executes image formation according to the color image forming mode selected by the user.

According to the present embodiment, in an image forming apparatus equipped with an ACS mechanism, even where the color image forming mode to be applied to the color image has for some reason not been selected, the user is able to select the color image forming mode and suitable image formation can be executed.

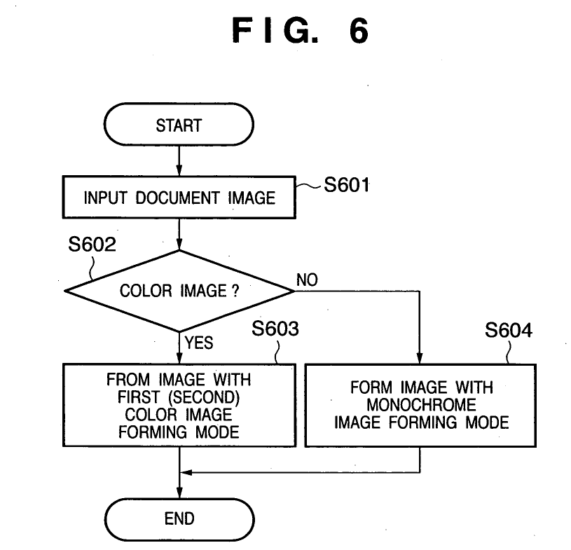

FIG. 6 is another illustrative flow chart showing the control method of the image forming apparatus according to the present embodiment, where the color image forming mode to be executed when a color image is detected by the ACS mechanism is statically assigned.

In step S601, the image input unit 102 inputs a document image in response to an instruction from the user. In step S602, the color/monochrome discriminator 130 identifies the input document image as either a color image or a monochrome image. If in step S602 it is determined that the input document image is a color image, then the process proceeds to step S603. Then, in step S603, in the case of a color image, the image forming unit 104 forms a color image according to the statically assigned first or second color image forming mode. In particular, in a use environment that attaches importance to the quality of the color image, it is preferable to statically assign the color image forming mode so as to form an image with the second color image forming mode. It should be noted that the color/monochrome discriminator 130 operates when it is set to enabled by the enable/disable switch 112. It goes without saying that, if the color/monochrome discriminator 130 is disabled, then the image forming mode selected automatically by the second designator described above is applied and an image formed.

By contrast, if in step S602 it is determined that the input document image is a monochrome image, then the process proceeds to step S604 and the image forming unit 104 forms an image with the monochrome image forming mode.

According to such an embodiment, an image forming apparatus having a discrimination mechanism that determines if an input document image is a color image or a monochrome image applies a statically assigned color image forming mode and forms an image if the input document image is identified as a color image, thereby eliminating the need for the user to selects the color image forming mode each time an image is formed and thus saving time and trouble. In addition, the monochrome image forming mode is applied if the input document image is identified as a monochrome image, thereby enabling the wastage that occurs whenever color consumable material is used despite the fact that the input document image is a monochrome image to be controlled. Accordingly, the working life of the color consumable material can be extended.

### Second Embodiment

A description is now given of a more detailed example of the embodiment described above.

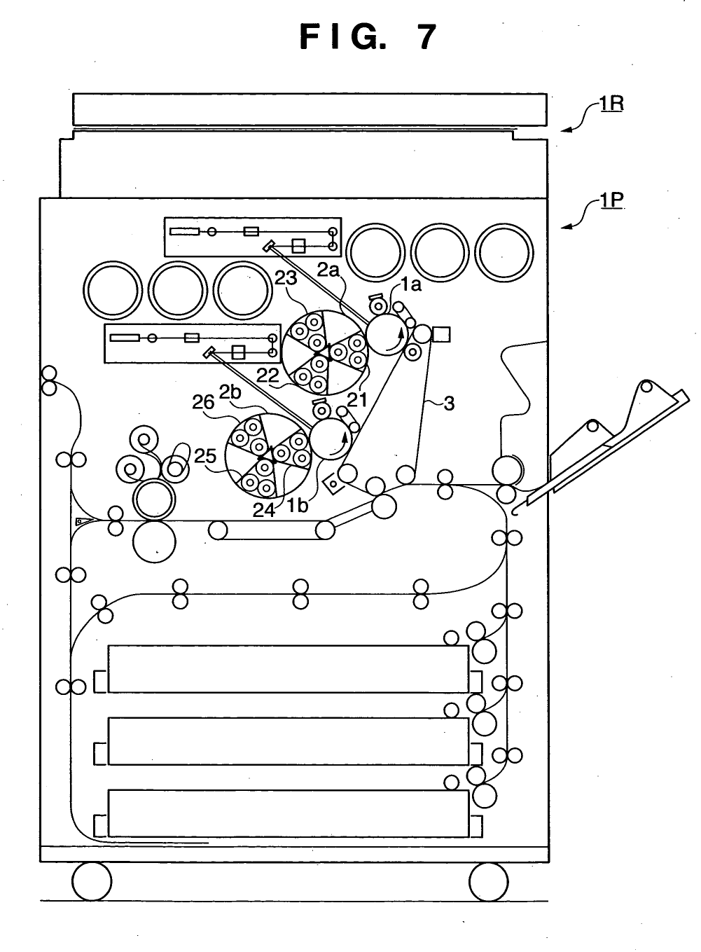

FIG. 7 is a diagram showing a schematic cross-sectional view of an electrophotographic full color image forming apparatus that is one example of the image forming apparatus according to the present embodiment. The full color image forming apparatus has a digital color image reader 1R on top and a digital color image printer 1P below.

In the reader 1R, the document is scanned by a full color CCD sensor and a color-separated image signal is obtained. The color-separated image signal is usually sent to the printer 1P after undergoing some sort of image processing.

In addition to the signals from the reader 1R, the printer 1P is also similarly sent image signals from a computer and image signals from a FAX machine. As an example, the description here assumes that the printer 1P operates based on an image signal from the reader 1R.

In the printer 1P, two photoconductive drums 1a, 1b are image carriers. This image forming apparatus employs a rotary development system, and is provided with two rotaries 2a, 2b. Rotary 2a is provided with three developing units 21, 22, 23, each loaded with toners of different colors. In addition, rotary 2b is also provided with three developing units 24, 25, 26, each also loaded with toners of different colors.

In this example, the image forming apparatus carries out image formation using six colors, that is, using two colors light magenta (Lm) and light cyan (Lc) in addition to the four colors, magenta (M), cyan (C) yellow (Y) and black (K) used in the conventional color copier. It should be noted that there may also be more than four developing units.

A pixel (dot) formed using a light-color toner does not show up more than a pixel formed using a toner of normal density, and as a result a very smooth, non-grainy image can be reproduced. In other words, high-quality images can be achieved. It should be noted that the light cyan and the light magenta toners each use the same pigments as the cyan and magenta toners do, the only difference being the amounts of pigments contained therein.

In this example, the developing units 21-26 can be filled not only with magenta (M), cyan (C) yellow (Y) and black (K) but also with light magenta (Lm) and light cyan (Lc) as well.

To describe the image forming process simply, the image signal from the reader 1R is converted into a light signal and projected onto the surfaces of the photoconductive drums 1a, 1b, where latent images are formed.

Next, rotaries 2a, 2b are rotated, predetermined developing units are moved into developing positions over the photoconductive drums 1a, 1b, and thereafter the developing units are activated, the latent images on the photoconductive drums 1a, 1b are developed, and visible images (toner images) are formed on the photoconductive drums 1a, 1b. The toner images formed on the photoconductive drums 1a, 1b are then temporarily transferred to an intermediate transfer belt 3. The respective toner images are then superimposed one atop the other on the intermediate transfer belt 3.

Finally, the toner images on the intermediate transfer belt 3 are transferred to transfer material and an image is formed.

One example here is the first color image forming mode. A description is given of a four-color image forming mode that uses magenta, cyan, yellow and black. A magenta developing unit 21 that contains magenta toner and a yellow developing unit 22 that contains yellow toner are disposed within the photoconductive drum 1a. At the same time, a cyan developing unit 24 that contains cyan toner and a black developing unit 25 that contains black toner are disposed within the photoconductive drum 1b. Images in these four colors can be formed, in the foregoing order, while the intermediate transfer belt 3 rotates twice.

It should be noted that it is possible to fill the developing unit 23 with light cyan toner and to fill the developing unit 26 with light magenta toner. However, these two colors are not used in the four-color image forming mode, being used instead in the five-color or six-color image forming modes of the second color image forming mode. In the six-color image forming mode, the intermediate transfer belt 3 rotates through three cycles to complete the formation of images in all six colors.

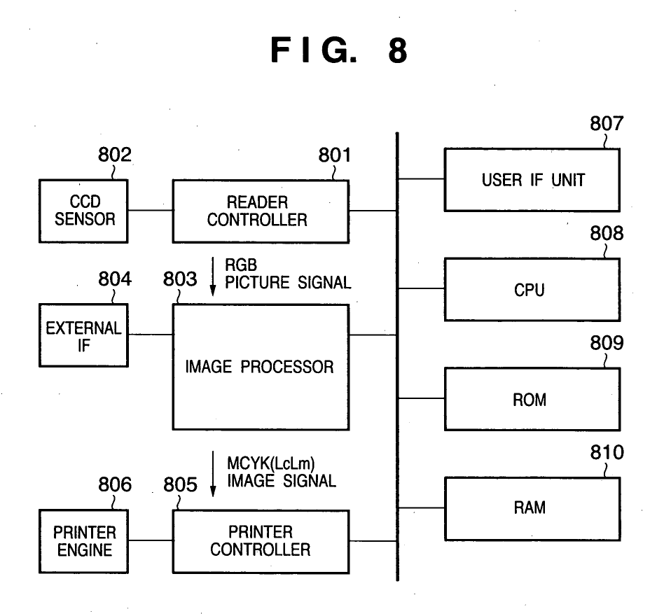

FIG. 8 is a block diagram showing the controller of the image forming apparatus according to the present embodiment. A reader controller 801 is a control unit that controls each mechanism of the above-described reader 1R, and is composed primarily of a CPU, a ROM, a RAM, and the like. The reader controller 801 moves the reader 1R scanning mirror and exposure light and controls a CCD sensor 802 used for image scanning. Furthermore, the reader controller 801 sends RGB image signals obtained by the CCD sensor 802 to an image processor 803.

The image processor 803 receives RGB image signals output from the reader controller 801 or an external IF 804, converts them into MCYK (LcLm) signals, and outputs the MCYK (LcLm) signals to a printer controller 805. It should be noted that whether a four-color image signal is output or a six-color image signal is output depends on which color image forming mode has been selected.

The printer controller 805 receives the MCYK (LcLm) signals output from the image processor 803 and drives a printer engine 806 in response to those signals. The printer engine 806 is the above-described photoconductive drums 1a, 1b, the rotaries 21, 2b, a transport mechanism, and the like.

A user interface (IF) unit 807 includes a display unit and an input unit, and is used to provided information to the user, to input instructions from the user, and so forth. The user interface (IF) unit 807 may, for example, be comprised of a display device, a key input device and the like.

A CPU 808 is a control circuit that exerts overall control of the image forming apparatus based on a control program stored in a ROM 809 and on instructions input from the user interface (IF) unit 807. A RAM 810 is a storage device that is used as a work area.

The above-described ACS function (automatic color mode selection function) can, for example, be implemented as follows: When the image processor 803 receives a digital RGB image signal of a document image output from the reader controller 801, it corrects blurring between pixels and colors of the RGB signal using a shift memory, for example, and then converts the RGB image signal into a MCY image signal using a complementary color conversion circuit. Furthermore, using a black extraction circuit, the image processor 803 extracts a black color area of the image from the MCY image signal and outputs a K (black) image signal for the extracted black area. Based on the black color area identified by the black extraction unit, the image processor 803 or the CPU 808 can determine if the image is a full color image or a monochrome image. In other words, the image processor 803 identifies the image as a monochrome image if the black area occupies more than a certain surface area within the document image, and as a full color image if the black area does not occupy more than a certain surface area within the document image. The results of this determination are then sent to the CPU 808.

FIG. 9 is a diagram showing an example of a user interface (control panel) of the image forming apparatus according to the present embodiment. It should be noted that control of the input-output process of the user IF unit 807 is executed by the CPU 808. In addition, the CPU stores and saves the settings input via the user IF unit 807 in the RAM 810 or on the ROM 809.

Reference numeral 901 designates a display unit. The display contents are displayed according to the setting mode, simplifying mode setting. For example, in response to depression of the cursor keys 911-914, the CPU 808 moves the cursor displayed on the display unit 901. Then, when depression of the OK key 910 is detected, the CPU 808 stores the settings selected by the cursor in the storage device. It should be noted that the display unit 901 can also be composed of a touch panel.

Reference numeral 902 designates a ten key, or numeric keypad, and is used mainly to input numbers, such as setting the number of pages of images to be formed, setting the mode, and so forth. Reference numeral 903 is a clear/stop key, used to clear the set number of pages of images to be formed, to stop the image formation operation, and so forth. Reference numeral 904 designates a reset key, which resets the set number of pages of images to be formed, the operating mode, the mode for selecting the source of paper supply and the like to a standard value. Reference numeral 905 designates a start key, which when pressed orders the start of the image formation operation.

It should be noted that, as the image forming modes of the image forming apparatus, there exist, for example, a BW mode that forms an image using only the black toner, a 4C mode that forms an image using toner of the four colors Y, M, C, K (a normal-quality mode), and a 6C mode that forms an image using toner of the six colors Y, M, C, K, Lc, Lm (a high-quality mode). Accordingly, color mode selection keys 921-923 are provided on the user interface. The color mode selection key 921 is the key for selecting the BW mode. The color mode selection key 922 is the key for selecting the normal quality mode. The color mode selection key 923 is the key for selecting the high-quality mode.

Reference numeral 920 designates the ACS mode setting key, and is the key for selecting whether or not to execute automatic identification of the document image as a monochrome image or as a full color image. By operating the ACS mode setting key 920, the ACS mechanism can be switched between enabled/disabled. Matters may be arranged so that the CPU 808 prohibits operation of any of the color mode selection keys 921-923 when the ACS mode is switched from disabled to enabled.

LED 930-933 light in response to the set ACS mode. For example, if the ACS mechanism has been set to enabled, then LED 930 lights. If the BW mode has been set to enabled, then LED 931 lights. If the 4c mode (normal quality mode) has been enabled, then LED 932 lights. If the 6C mode (high-quality mode) has been enabled, then LED 933 lights.

Setting keys 941, 942 for selecting a photo mode suitable for a photo image and a character mode suitable for a character image are provided on the user interface. When the character mode setting key 941 is pressed, the character mode is selected. When the character mode is selected, the image processor 803 executes a process that emphasizes black letter edge detection and character contrast, and therefore a print image of good character quality is obtained. When the photo mode setting key 942 is pressed, the photo mode with its good gradations of tone is selected.

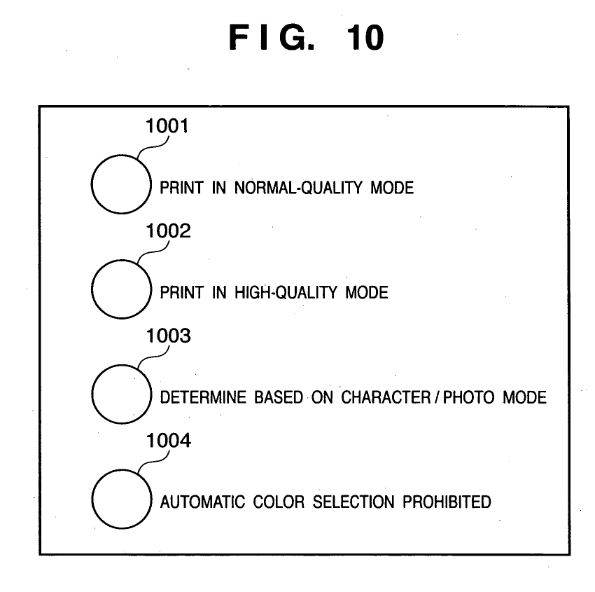

FIG. 10 is a diagram showing an example of a screen used to register an initial state regarding the print mode settings in the present embodiment. When the setting screen key 906 is pressed, the CPU 808 displays the screen shown in FIG. 10 on the display unit 901, which is one of the screens that accepts user settings. This screen is provided in order to reduce the time and trouble of setting the mode for the user. In other words, when the user does not perform a setting operation at each formation of an image, the CPU 808 through this screen acquires the default setting information to be adopted automatically. The acquired default setting information can then be stored on the ROM 809 or the like.

A designation key 1001 for pre-selecting a 4C mode (normal-quality mode) and a designation key 1002 for pre-selecting a 6C mode (high-quality mode) are provided as image forming modes when the ACS mechanism determines that the input document image is a full color image.

It should be noted that a character photo mode key 1003 is an option. When the character photo mode key 1003 is selected, the image forming apparatus operates as follows: If the ACS mechanism, which is enabled, determines that the input document image is a full color image, then the CPU 808 checks the settings for the character mode setting key 941 and the photo mode setting key 942 stored in the RAM 810 or the like. If the character mode has been set by the character mode setting key 941, then the image forming apparatus executes image formation in the normal-quality mode. On the other hand, if the photo mode has been set, then the image forming apparatus executes image formation in the high-quality mode. An automatic color section prohibition key 1004 is also an option. When the automatic color selection prohibition key 1004 is selected, the CPU 808 disables the ACS mechanism and always prompts the user to select the BW mode, the 4C mode or the 6C mode using the color mode selection keys 921-923. In other words, the ACS mode setting key 920 is disabled.

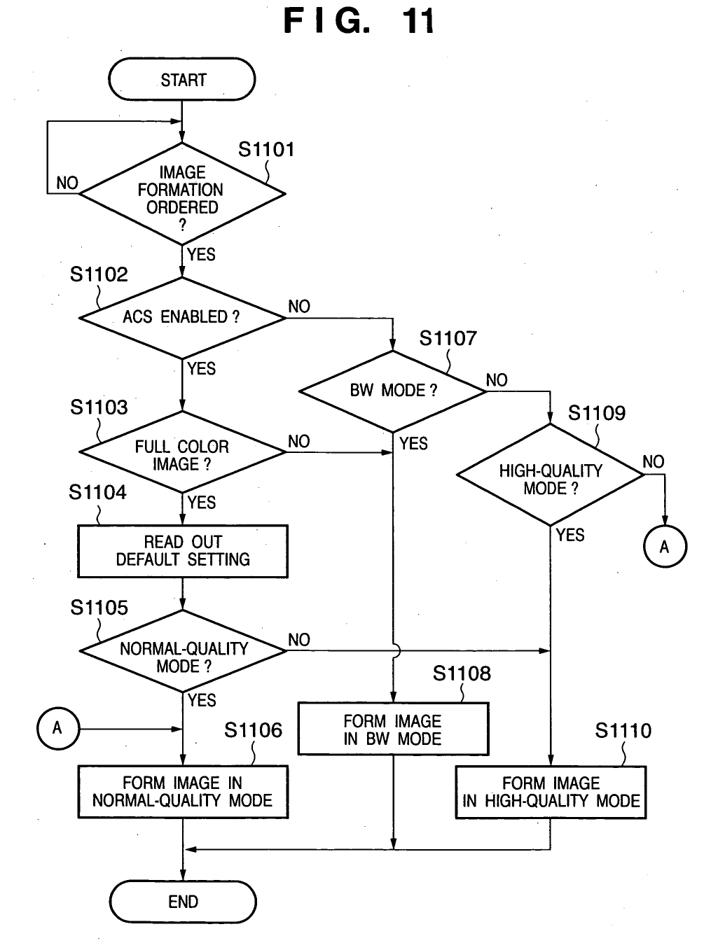

FIG. 11 is an illustrative flow chart of a control method for the image forming apparatus according to the present embodiment. In this example, the character/photo mode key 1003 is not provided on the user interface.

In a step S1101, the CPU 808 determines whether or not image form has been ordered by the user operating the start key 905. If image formation has been ordered, then the CPU 808 issues an image scan command to the reader controller 801 and the process proceeds to step S1102. The reader controller 801 controls the CCD sensor 802 and the like to scan the document image, generating an RGB image signal that is then sent to the image processor 803.

In step S1102, the CPU 808 determines whether or not the ACS mechanism has been enabled by the ACS mode key 920. For example, if the ACS mode setting key 920 is pressed before the instruction to start image formation is given, the CPU 808 sets the ACS mode flag stored in the RAM 810 to either 1 or 0. Here, 1 means that the ACS mechanism is enabled, and 0 means that the ACS mechanism is disabled. Accordingly, the CPU 808, by checking this flag, can determine whether or not the ACS mechanism has been set to enabled. If the ACS mechanism has been set to enabled, then the process proceeds to step S1103. If the ACS has been set to disabled, then the process proceeds to step S1107.

In step S1103, the CPU 808 issues a document image type identification command to the ACS mechanism contained in the image processor 803. The ACS mechanism contained in the image processor 803, when it receives such a command, identifies the document image as either a monochrome image or a full color image depending the black area of the document image and transmits the results of that determination to the CPU 808. The CPU 808, depending on the determination results that it receives, determines whether the image is a monochrome image or a full color image, and if the image is a full color image the process proceeds to step S1104.

On the other hand, if the CPU 808 determines that the input document image is a monochrome image, then the process proceeds to step S1108 and the CPU 808 issues a command to the image processor 803 and to the printer controller 805 to form a monochrome image. The image processor 803 carries out image processing suitable for the formation of a monochrome image and the image signal thus obtained is output to the printer controller 805. The printer controller 805 controls the printer engine 806 in response to the image signal from the image processor so as to use only the black toner to form a monochrome image.

In step S1104, the CPU 808 reads out the default setting information from either the RAM 810 or the ROM 809. The default setting information is that which has been registered via the screen (shown in FIG. 10) for registering the initial state described above.

In step S1105, the CPU 808, based on the default setting information read out, determines whether or not the apparatus has been set to the normal-quality mode. If the apparatus has been set to the normal-quality mode, then the process proceeds to step S1106 and the CPU 808 issues a command to the image processor 803 and to the printer controller 805 to form a color image in the normal-quality mode. The image processor 803 carries out image processing suitable for the formation of a color image and outputs the YMCK image signal thus obtained to the printer controller 805. The printer controller 805, in response to the YMCK image signal from the image processor 803, controls the printer engine 806 so as to use four toners and form a color image.

By contrast, if the apparatus has not been set to the normal-quality mode (in other words, the apparatus has been set to the high-quality mode), then the process proceeds to step S1110 and the CPU 808 issues a command to the image processor 803 and to the printer controller 805 to form a color image in the high-quality mode. The image processor 803 then carries out image processing suitable for the formation of a high-quality color image and outputs the YMCKLcLm image signal thus obtained to the printer controller 805. The printer controller 805, in response to the YMCKLcLm image signal from the image processor, then controls the printer engine 806 so as to use the six YMCKLcLm toners and form a color image.

In the foregoing step S1102, if it is determined that the ACS mechanism has been set to disabled, then the process proceeds to step S1107 and the CPU 808 determines if the apparatus has been set to the BW mode by the color mode setting key 921. If the apparatus has been set to the BW mode, then the process proceeds to step S1108 and a monochrome image is formed.

On the other hand, if the apparatus has not been set to the BW mode, then the process proceeds to step S1109 and the CPU 808 determines if the apparatus has been set to the high-quality (6C) mode by the color mode setting key 923. If the apparatus has been set to the high-quality node, then the process proceeds to step S1110 and a high-quality color image is formed. If the apparatus has not been set to the high-quality mode, then the process proceeds to step S1106 and a normal-quality color image is formed.

According to such an embodiment, in an image forming apparatus having an ACS mechanism that determines whether an input document image is a color image or a monochrome image, an image is formed using a color image forming mode selected in advance by the default setting if the image is identified as a color image. As a result, the user is no longer required to select the color image forming mode at each image formation. Thereby saving time and trouble. In addition, a monochrome image forming mode is applied when the input document image is identified by the ACS mechanism as a monochrome image, thereby enabling the wastage that occurs whenever color consumable material is used despite the fact that the input document image is a monochrome image to be controlled. Consequently, the life of the color consumable material can be extended.

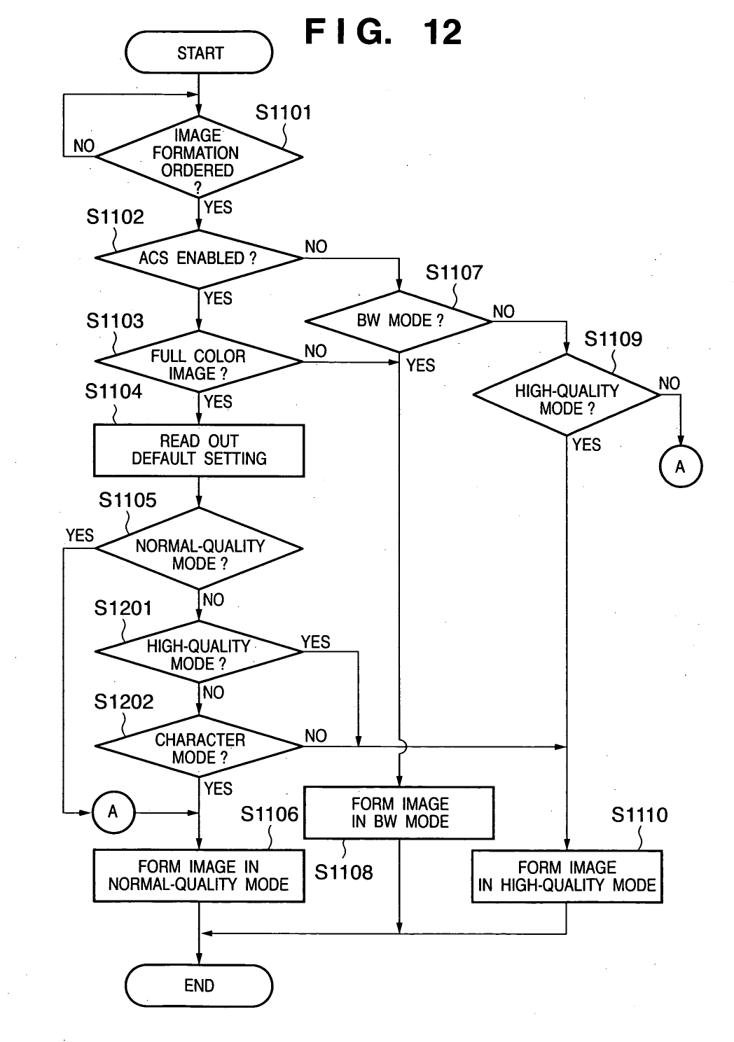

FIG. 12 is another illustrative flow chart of a control method for the image forming apparatus according to the present embodiment. In this example, the character/photo mode key 1003 is provided on the user interface. A description of those parts that are the same as those shown in FIG. 11 and a description with respect thereto is omitted.

In a case in which the ACS mechanism is enabled and moreover the input document image is identified as a color image, in step S1104 the default setting information is read out. In step S1105, the CPU 808 determines from the default setting information whether or not the apparatus has been set in advance to the normal-quality mode. If the apparatus has not been set in advance to the normal-quality mode, then the process proceeds to step S1201.

In step S1201, the CPU 808 determines from the default setting information whether or not the apparatus has been set in advance to the high-quality mode, and if so the process then proceeds to step S1110 above-described and a color image is formed in the high-quality mode.

On the other hand, if the apparatus has not been set to the high-quality mode, then the process proceeds to step S1202 and the CPU 808 checks the settings for the character/photo mode setting keys 941, 942 and determines whether or not the apparatus has been set in advance to the character mode. If the apparatus has been set in advance to the character mode, then the process proceeds to step S1106 and a color image is formed in the normal-quality mode. By contrast, if the apparatus has not been set to the character mode (in other words, the apparatus has been set to the photo mode), then the process proceeds to step S1110 and a color image is formed in the high-quality mode.

The present embodiment makes it possible to apply suitably the preferred image forming mode in terms of preserving consumable material while reflecting the desires of the user in an image forming apparatus having an ACS mechanism, a character mode and a photo mode, even where the operation of the ACS mechanism or the like is enabled. In other words, as can be understood by those of ordinary skill in the art, the high-quality mode, because it can form images of higher quality compared to the normal-quality mode, is suitable to image formation in the photo mode, whereas the normal-quality mode is relatively better suited to the character mode. In other words, when the user selects the character mode, it is likely that relatively low-quality image formation is desired. Conversely, when the user selects the photo mode, it is likely that relatively high-quality image formation is desired.

As already described using FIGS. 4 and 5, when dividing the document image into a character area and a photo area and applying separate image forming modes to each area, it cannot be determined which image forming mode is to be used with each of these areas even by checking the condition of the settings of the character mode setting key 941 and the photo mode setting key 942. Therefore, even where the ACS mechanism and the area division function have been set to enabled, some sort of coping method is necessary.

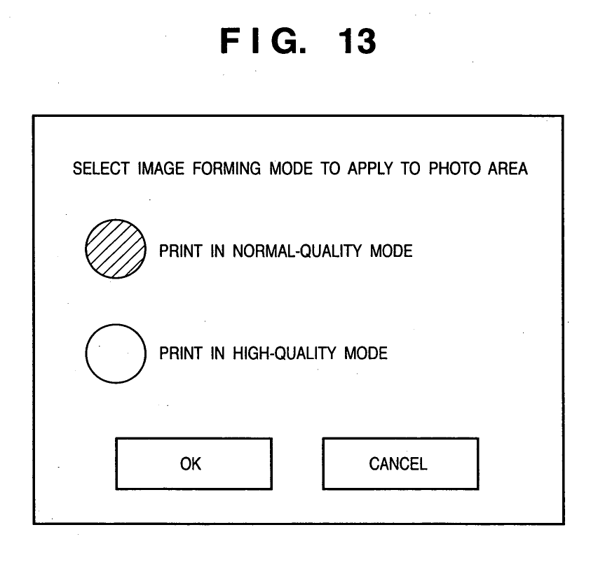

FIG. 13 is a diagram showing an illustrative user interface for selecting an image forming mode in the image forming apparatus according to the present embodiment. In step S406 and step S504 described above, the CPU 808 displays on the display unit 901 of the user IF unit 807 the user interface shown in FIG. 13 and allows the user to select the image forming mode to be applied to the photo area. It should be noted that although in this example the image forming mode for only the photo area is selected, the image forming mode for the character area can also be selected using the user interface displayed before and after the present one.

### Other Embodiments

Although in the foregoing embodiments the description pertains to an electrophotographic image forming apparatus, it goes without saying that the present invention can also be adapted to an image forming apparatus that employs other image forming methods, such as inkjet, offset printing, and the like.

In addition, although the foregoing embodiments describe a first color image forming mode and a second color image forming mode as the color image forming modes, the present invention is not limited thereto. In other words, the present invention is also applicable to an image forming apparatus having three or more color image forming modes.

Although a variety of embodiments have been described in detail above, it should be noted that the present invention can be applied to an apparatus comprising a single device or to a system constituted by a plurality of devices, for example, scanner, printer, PC, copier, multifunction device or facsimile machine.

Furthermore, the invention can be implemented by supplying a software program (that is, a program corresponding to the flow charts shown in FIGS. 2-6, 11 and 12 of these embodiments), which implements the functions of the foregoing embodiments, directly or indirectly to a system or apparatus, reading the supplied program with a computer of the system or apparatus, and then executing the program code.

Accordingly, since the functions and processes of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by a interpreter, or scrip data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

In addition, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

The present invention can be applied a system constituted by a plurality of devices, or to an apparatus comprising a single device. Furthermore, it goes without saying that the invention is applicable also to a case in which the object of the invention is attained by supplying a program to a system or apparatus.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-287994 filed on Sep. 30, 2004, which is hereby incorporated by reference herein.

What is claimed is:

1. An image forming apparatus comprising:
an image input unit that inputs a document image;
an area recognition unit that recognizes a plurality of different areas contained in the document image;
an identification unit that identifies the document image as either a color image or a monochrome image;
a selection unit that allows a user to select either a first color image forming mode that uses recording agents of m colors (where m is a natural number equal to or greater than 4) or a second color image forming mode that uses recording agents of n colors (where n is a natural number equal to or greater than m+1) as an image forming mode applied to at least one of the areas recognized by the area recognition unit if the identification unit identifies the document image as a color image; and
an image formation unit that applies the image forming mode selected by the selection unit to at least one area and forms an image.

2. The image forming apparatus according to claim 1, wherein the area recognition unit recognizes a character area and a photo area contained in the document image.

3. An image forming apparatus control method comprising:
an image input step of inputting a document image;
an area recognition step of recognizing a plurality of different areas contained in the document image;
an identification step of identifying the document image as either a color image or a monochrome image;
a selection step of allowing a user to select either a first color image forming mode that uses recording agents of m colors (where m is a natural number equal to or greater than 4) or a second color image forming mode that uses recording agents of n colors (where n is a natural number equal to or greater than m+1) as an image forming mode applied to at least one of the areas recognized in the area recognition step if the document image is identified as a color image in the identification step; and
an image formation step of applying the image forming mode selected in the selection step to at least one area and forming an image.

4. The image forming apparatus control method according to claim 3, wherein a character area and a photo area contained in the document image are recognized in the area recognition step.
